(19) United States
(12) Patent Application Publication
(10) Pub. No.: US 2009/0112739 A1
(43) Pub. Date: Apr. 30, 2009

(54) PRODUCT MANAGEMENT SYSTEM AND METHODS

(76) Inventors: Frank Barassi, Montreal (CA); Sebastien Boulais, McMasterville (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 12/262,894

(22) Filed: Oct. 31, 2008

(30) Foreign Application Priority Data
Oct. 31, 2007 (CA) 2,609,107

(51) Int. Cl. G06Q 10/00; G06F 15/177

(52) U.S. Cl. 705/28; 709/222

(57) ABSTRACT

Product supply management system and methods are provided. The system and methods are typically adapted to be used with the manufacture, distribution and sale of programmable electronic devices. The method generally comprises the tracking of each programmable device through each participant in the supply chain, from the manufacturer to the retailer, and the programming of each programmable device at the retailer's premise with generally individualized software. The tracking information, collected via different stations and transmitted to a central server via a communication network, is then typically used to identify each of the participants in the supply chain through which each of the programmable devices has transited. This tracking information is then typically used to monitor inventory and to redistribute commissions to each participant.

### CROSS-REFERENCE TO RELATED APPLICATIONS

The present patent application claims the benefits of priority of commonly assigned Canadian Patent Application No. 2,609,107, entitled “Production Distribution Management System” and filed at the Canadian Intellectual Property Office on Oct. 31, 2007.

### FIELD OF THE INVENTION

The present invention generally relates to the field of product distribution and management along supply chains. More particularly, the present invention relates to systems and methods for managing and controlling the distribution of products.

### BACKGROUND OF THE INVENTION

In our modern economy, product distribution management such as supply chain management and logistic management, generally try to assure that transformed or manufactured products ultimately end up in the hands of end users and customers.

To do so, supply chain management usually implies some sort of tracking of the products as they transit through different participants (e.g. manufacturers, distributors, retailers, etc.) in the supply chain. The tracking provides information about the location of the products which can then be used to determine level of inventory, located particular shipment (e.g. for recall purpose), etc.

Conventional supply chain management generally works well for products which are generally ready to be used by end-users and customers. However, conventional supply chain management has its limitations when the products must be individually programmed before being sold to end-users and customers.

Consequently, there is a need for a product distribution management system and method which improve over the prior art.

### SUMMARY OF THE INVENTION

The present invention mitigates the aforesaid and other shortcomings of the prior art by generally providing a novel system and its related methods for the management of products along a supply chain. The present system and method are particularly, though not exclusively, adapted to be used with the manufacture, distribution and sale of programmable electronic devices such as vehicle integration modules (e.g. databus modules) used in the automobile industry.

The method generally comprises the tracking of each programmable device as they transit through each participant in the supply chain, starting from the manufacturer, through each distributor, and down to the retailer. The method also generally comprises the programming of each programmable device, at the retailer's premise, with generally at least partially individualized software. The programming could however possibly occur at the customers' premises.

The tracking information is generally collected at each participant via different stations connected to a central server via a communication network such as, but not limited to, the Internet. The tracking information generally comprises an indication of the particular participant in the supply chain and an indication of the device. The tracking information can be used to know, with more or less accuracy, the path taken by each device through the supply chain.

The tracking information can also be used to determine the inventory level of each participant.

To program each device at the retailer's premise, each retailer is provided with a programming station. The programming stations are also connected to the central server via a communication network such as, but not limited to, the Internet. The central server generally has stored therein a plurality of different softwares which can be retrieved by the programming stations during the programming sequence. Hence, when a device needs to be programmed, the device is connected to the programming station which detects the unique serial number of the device and transmits it to the central server in order for the central server to retrieve the specific information (e.g. type, version, configuration, etc.) about the device. The specific information, or at least a portion thereof, is then transmitted back to the programming station for display thereon. After selecting the required features of the desired software on the programming station, the appropriate software is retrieved from the central server and programmed onto the device which can then be disconnected from the programming station and used.

In accordance with the invention, as the device is programmed, an indication of the particular software written onto the device is transmitted by the programming station to the central server such as to update the status of the particular device. Hence, the central server is preferably always up-to-date.

In accordance with another aspect of the present invention, a payment must generally be provided before the software can be retrieved and programmed onto the device.

The skilled addressee will note that one of the main advantages of the present invention is that as each device is tracked through the supply chain and ultimately needs to be programmed to be useful, each participant in the supply can buy devices from the preceding participants at almost cost level (e.g. hardware cost plus minimal profit margin). Then, as the software provider receives payments for the programming of the devices, a portion of the profit from the software purchase cost can be redistributed by the software provider to each participant in the supply chain using the tracking information.

This provides the significant advantage that each participant does not need to pay upfront the total costs and profit margin of the preceding participant, thereby reducing the strain of their cashflow. This provides the ability for each distributor and retailer to buy more devices in advance.

According to another aspect of the present invention, each product needs not to be individually tracked through the supply chain. By providing machine-readable codes such as, but not limited to, barcodes add/or RFID tags containing information about several products shipped together, the tracking of a shipment can be equal to the tracking of each product contained in the particular shipment.

As the skilled addressee will understand, tracking shipments instead of tracking individual products contained therein considerably reduces the time required to process the tracking.

Understandably, several shipments shipped together could also be tracked via a single machine-readable identifier containing information about each shipment. The present invention is not so limited.

It is to be understood that through the present description, manufacturers, distributors and retailers are not mutually exclusive roles in the supply chain. In fact, a distributor could also be a retailer for local customers.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a schematic view of the tracking and programming system.

FIG. 2 is a schematic view of an exemplary loading station.

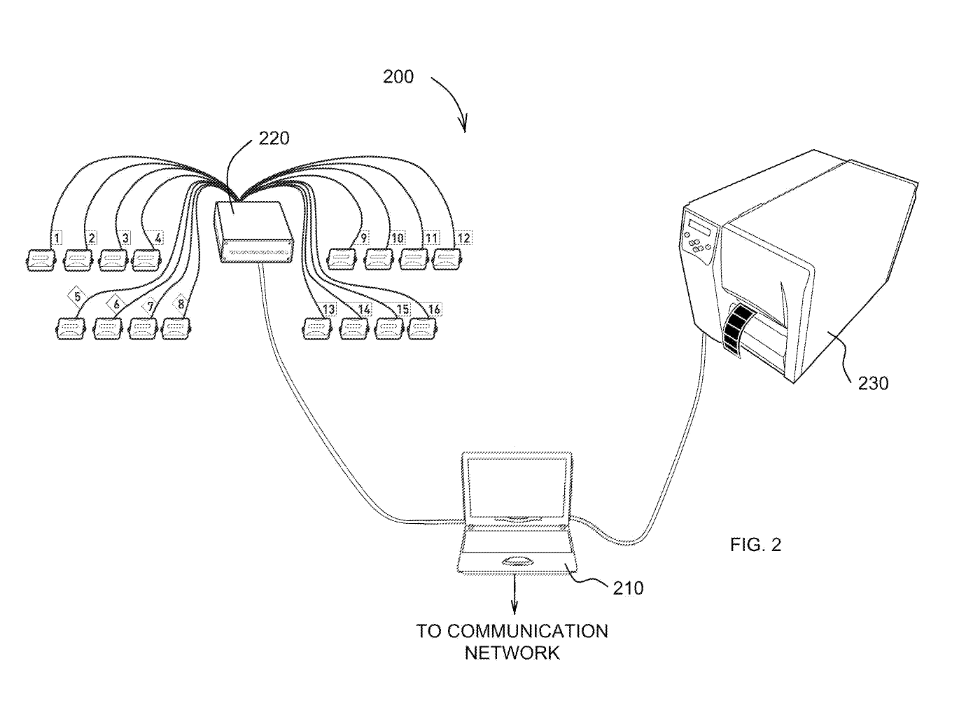

FIG. 3 is a schematic view of an exemplary tracking station.

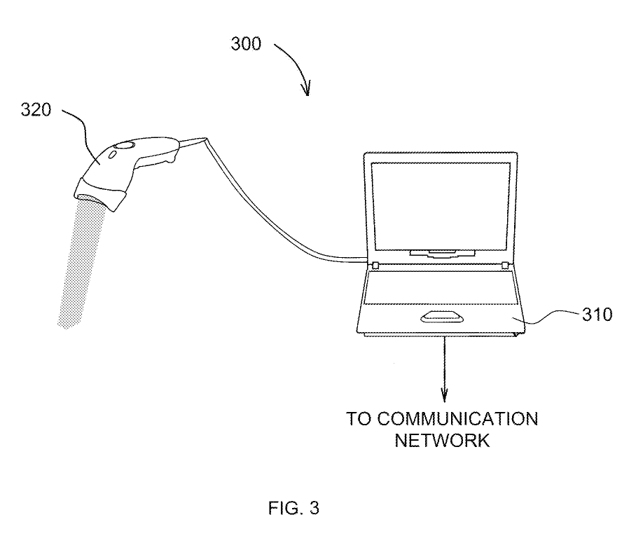

FIG. 4 is a schematic view of an exemplary programming station.

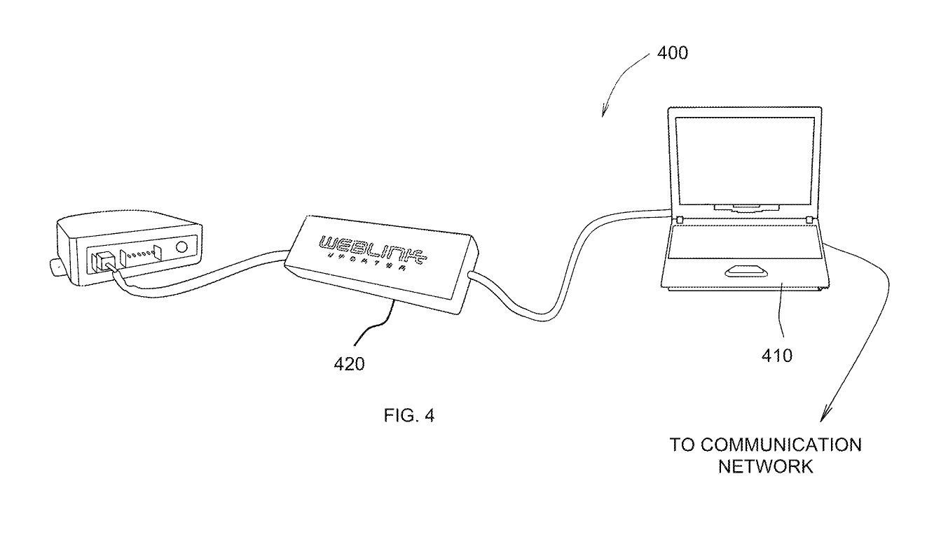

FIG. 5 is a flowchart of an exemplary tracking method incorporating the principles of the invention.

FIG. 6 is a flowchart of an exemplary programming method incorporating the principles of the invention.

### DETAILED DESCRIPTION OF THE PREFERRED EMBODIMENT

Novel product management system and methods will be described hereinafter. Although the invention is described in terms of specific illustrative embodiments, it is to be understood that the embodiments described herein are by way of example only and that the scope of the invention is not intended to be limited thereby.

General System

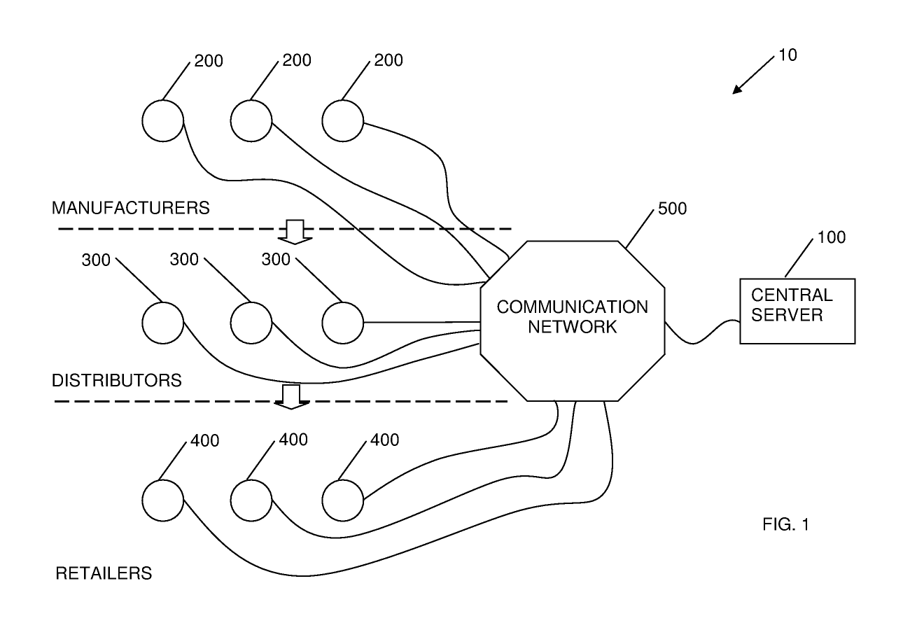

Referring first to FIG. 1, the general system 10 embodying the principles of the invention is depicted. The system 10 comprises a central server 100 which is connected to each participant in the supply chain. As depicted in FIG. 1, the participants can generally be partitioned into three groups: manufacturers, distributors and retailers.

Though the three groups are shown as distinct, the person skilled in the art will understand that certain participants could be part of two groups at the same time. Hence, a distributor could also be a retailer for its local customers. The present invention is therefore not so limited.

In addition to the central server 100, the system 10 also comprises a plurality of loading stations 200 located at the manufacturers' premises, a plurality of tracking stations 300 located at the distributors' premises and a plurality of programming stations 400 located at the retailers' premises. The loading stations 200, the tracking stations 300 and the programming stations 400 are all operatively connected to the central server 100 via a communication network 500 such as, but not limited to, the Internet.

The central server 100 acts as the repository of all the tracking information generated by the loading stations 200, the tracking stations 300 and the programming stations 400. The central server 100 is also the repository of all the different softwares that can be programmed onto the devices.

As such, the central server 100 is generally embodied a computer system comprising at least a processing unit, one or more data storage units, a network interface unit, and a display unit. Understandably, the data storage units, the network interface unit and the display unit are all operatively in communication with the processing unit.

The loading stations 200, which are generally located at the manufacturers' premises, are generally adapted to attribute unique serial number to each of the devices and to transmit the serial numbers generated to the central server 100 such that a tracking record can be created on the central server 100 for each device.

The loading station 200 is typically embodied as computer system 210 to which are operatively connected a loading module 220 and an identifier generating module 230. The loading station 200, via the computer system 210, is operatively connected to the central server 100 via the communication network 500. The loading station 200 is thus adapted to transmit and receive information to and from the central server 100.

The loading module 220 is configured to interface each of the devices such as to be able to preload them with a unique serial number and preferably with a boot loading software.

In the present preferred embodiment, the loading module 220 can preferably interface and preload several devices simultaneously.

For its part, the identifier generating module 230 is configured to generate machine-readable identifiers respectively associated with the serial numbers generated by the computer system 210 and loaded onto the devices by the loading module 220. The identifiers can then be mounted or applied to the devices or to boxes therefor.

In the present preferred embodiment, the identifiers generated are stickers provided with unique barcodes. Hence, in the present preferred embodiment, the identifier generating module 230 is typically a printer connected to the computer system 210. Still, the identifier generating module 230 could generate other forms of identifiers such as, but not limited to, RFID tags. The present invention is thus not limited to a particular form of identifiers.

It is to be understood that the loading station 200 could possibly be embodied as a unitary station comprising the computer system 210, the loading module 220 and the identifier generating module 230.

The tracking stations 300, which are generally located at the distributors' premises, are generally adapted to retrieve information from the identifiers such as to be able to identify the devices. The tracking stations 300 are also adapted to transmit the information retrieved from the identifiers to the central server 100 such as to update the tracking records of the devices.

The tracking station 300 is typically embodied as computer systems 310 to which is connected the reading module 320. The tracking station 300, via the computer system 310, is operatively connected to the central server 100 via the communication network 500. The tracking station 300, as the loading station 200, is thus adapted to transmit and receive information to and from the central server 100.

The reading module 320 is configured to read the identifiers or otherwise extract information therefrom in order to identify the devices. The information so retrieved is then processed by the computer system 310 and transmitted to the central server 100 for updating the tracking records of the devices.

In the present preferred embodiment, since the identifiers are barcodes, the reading module is typically a barcode reader. However, should the identifier be, for example, a RFID tag, the reading module would correspondingly be a RFID tag reader. Hence, the reading module 320 must therefore correspond to the identifiers to be read.

The programming stations 400, which are generally located at the retailers' premises, are generally adapted to interface each device, to retrieve the appropriate software from the central server 100 and to program the device with the retrieved software. The programming stations 400 are also adapted to transmit information retrieved from the device to the central server 100 such as to update the tracking record of the device.

The programming station 400 is typically embodied as a computer system 410 to which is connected an interface module 420. The programming station 400, via the computer system 410, is operatively connected to the central server 100 via the communication network 500. The programming station 400, as the loading station 200 and the tracking station 300, is thus adapted to transmit and receive information to and from the central server 100.

The interface module 420 is configured to interface the programmable device during the retrieval of its serial number and during the programming thereof. A programming station 400 could be provided with several interface modules 420, each adapted to interface a specific type of devices.

In the present preferred embodiment, the interface module 420 is physically connected to the device. However, in variant of the invention, the interface module 420 could interface the device wirelessly.

In the present preferred embodiment, the computer system 210, 310 and 410 are preferably all provided with the necessary softwares to function properly with their respectively associated modules.

Tracking Method

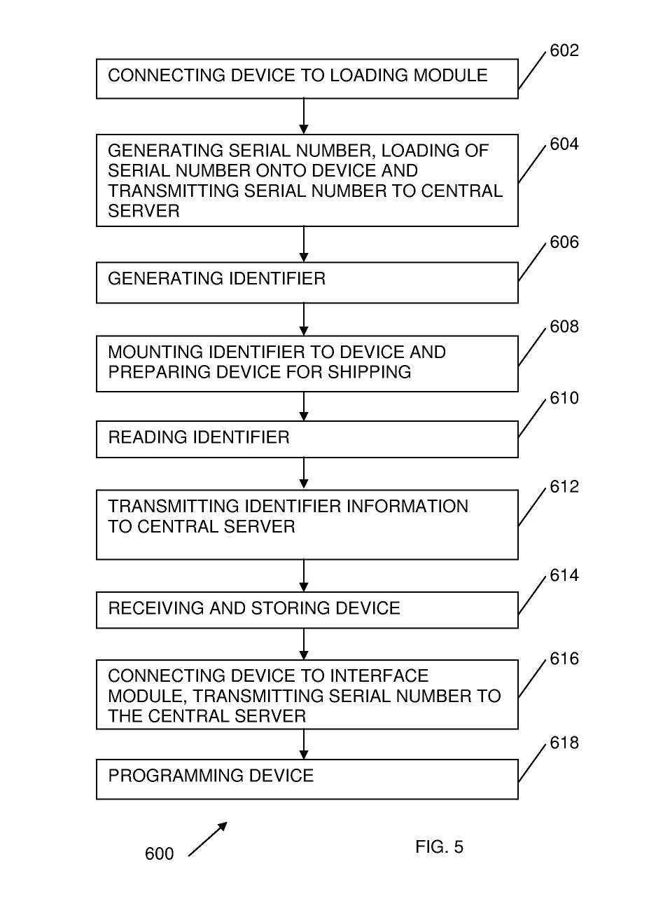

FIG. 5 depicts an exemplary method 600 for effectively tracking devices through a supply chain.

At step 602, a device, which has been assembled by the manufacturer and which has preferably been previously tested, is connected to the loading module 220 of the loading station 200.

At step 604, the computer system 210 generates a unique serial number which is then written onto the device via the loading module 220. Still at step 604, the computer system 210 transmits the serial number previously generated to the central server 100 such that a tracking record can be created for the device.

At step 606, the computer system 210 transmits the serial number to the identifier generating module 230 such that a unique machine-readable identifier can be generated for the device. The identifier preferably contains identifying information which is uniquely associated to the serial number of the device.

At step 608, the identifier is applied or otherwise mounted to the device or its packaging. At this point, the device is generally ready to be prepared and shipped to the distributor.

Understandably, though the aforementioned steps seems to indicate that each device is loaded and identified individually and sequentially, it is to be understood that several devices could be loaded (with different serial numbers) and identified (with different identifiers) substantially simultaneously. The aforementioned steps are therefore only illustrative.

At step 610, the device is received by the distributor and its identifier is read by the reading module 320 of the tracking station 300.

At step 612, an indication of the distributor, in addition to the information retrieved from the identifier, are transmitted to the central server 100 such as to update the tracking record of the device. At this point, the device is ready to be shipped to another distributor (e.g. a sub-distributor, a local distributor, etc.) or to a retailer.

If the device is shipped to another distributor, then steps 610 and 612 of the tracking method are repeated at the next distributor. If the device is shipped to a retailer, then the method proceeds to step 614.

In variant of the present invention, several devices, each having its own identifier, are packaged and shipped together in shipments. Hence, in order to reduce the tracking burden, other machine-readable identifiers could be provided for the shipments. Understandably, the information contained on the identifiers of the shipments would be associated to the serial number, or the identifier, of each device contained in the shipments.

Accordingly, when a distributor would receive one or more shipments, the distributor would only need to read the identifier(s) of the shipment(s), with the reading module 320. Being associated with the serial number, or the identifier, of each device in the shipment(s), the information retrieved from the identifier(s) of the shipment(s) would allow the update of the tracking records of each device in the shipment(s) without having to read the identifier of each device.

Understandably, reading identifiers on shipments instead of reading the identifiers of each device can considerably reduce the tracking burden of distributors.

At step 614, the device is received by the retailer. Typically, at this point, the device is stored until it is needed for sale. When the device is ready to be sold, it is connected to the interface module 420 of the programming station 400.

At step 616, the serial number of the device is retrieved by the computer system 410, via the interface module 420, and is transmitted to the central server 100, with an indication of the retailer, such as to update the tracking record of the device.

At step 618, the computer system 410 retrieves the record of the device and display at least of portion of it. At this point, the device is ready to be programmed. The programming of the device is the object of the programming method described hereinbelow.

Hence, once a device is programmed and sold, there exists a tracking record on the central server 100 comprising information on each particular participant in the supply chain through which the particular device has transited.

Understandably, these records can be used and processed to determine the performance of each participant, the inventory level of each participant and the actual path taken by each device through the supply chain. However, in accordance with an important aspect of the invention, the actual path taken by a device through the supply chain can be used to redistribute a commission, a profit share, or any other form of monetary distribution, to each or some of the participants according to pre-established redistribution rules. The redistribution will be described in more details below.

The skilled addressee will understand that the aforementioned tracking method is a preferred embodiment. Hence, variants of the aforementioned tracking method exist.

For instance, in a first variant, the tracking by the distributors could be omitted. However, for such a tracking to function properly, it would be necessary either for manufacturers or for the retailers to transmit, typically in advance, to the central server 100, information concerning the identity of the distributor(s) through which the device(s) will transit. However, in this first variant, the whereabouts of the devices during transit through the distributors would be unknown.

In a second variant, the devices could be pre-programmed either at the manufacturers' premises or at the distributors' premises or re-programmed at the distributors' premises. In this variant, the manufacturers and/or the distributors would be provided with programming stations 400. Still, in this variant, the programming of the devices would generally need to be completed or customized and/or the devices would need to be activated at the retailer's premises in order to work.

In a third variant, should a manufacturer also be a distributor or should a distributor also be a retailer, the tracking of the devices by tracking stations 300 could be omitted at the distributor which also acts either as a manufacturer or a retailer.

In a fourth variant, a manufacturer could ship devices directly to retailers. In this variant, there would be no tracking by tracking stations 300.

In view of the variants described above, the skilled addressee will understand that the general tracking method can vary according to the particularity of a supply chain and its participants. The tracking method of the present invention is therefore not limited to the tracking method described above.

Programming Method

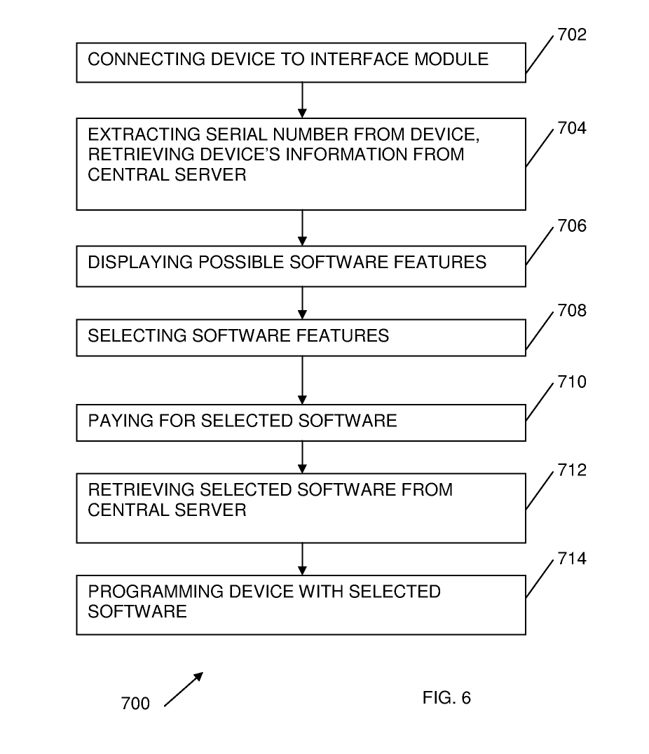

FIG. 6 depicts an exemplary method 700 for programming a device in accordance with the present invention.

At step 702, the device is connected to the interface module 420 of the programming station 400.

At step 704, the serial number of the device is retrieved by the computer system 410, via the interface module 420, and is transmitted to the central server 100. The central server 100 then sends back the record of the device including information specific to the device such as, but not limited to, model number, upgrade version, compatibility, etc. Still at step 704, this information is preferably display on the computer system 410 for review by the person in charge of programming the device.

At step 706, the computer system 410 typically displays a list of possible features than can be programmed into the device.

In the present preferred embodiment, the features actually displayed preferably take into account the specific information retrieved from the central server 100 such as to display features compatibles with the device.

At step 708, the desired features of the software are selected.

At step 710, the person in charge of the programming pays for the purchase of the particular software. The payment of the software is generally done via an online check out procedure generally known in the art of online selling.

At step 712, the central server, after receiving a confirmation of the payment, transmits the selected software to the computer system 410 of the programming station 400.

At step 714, the computer system 410, via the interface module 420, writes the selected software onto the device which, upon completion of the writing, can be disconnected and used as desired.

Preferably, as the new software is written onto the device, an indication concerning the selected software is transmitted to the central server 100 such as to update the record of the device. Such an indication can be retrieved later on should the device need to be reprogrammed or updated. Also, should particular software be defective, such an indication could be used to determine which devices have that particular defective software.

Understandably, certain of the steps described above could be performed separately or concurrently; the present invention is not so limited.

Profit Distribution Method

The total cost of a programmable device generally comprises the following costs:
a. hardware costs;
b. software costs;
c. patent license fees;
d. shipping and handling costs;
e. management costs;
f. profit margin.

In the present preferred embodiment, the participants in the supply chain, more particularly the distributors and the retailers, preferably only pay for the hardware costs of the devices and receive their share of the shipping and handling costs, management costs and profit margin only when the product is actually programmed and sold to a customer or end-user.

As the skilled addressee will note, since the device which has been programmed has been tracked through preferably each participant in the supply chain, the tracking record stored on the central server 100 contains an indication of each participant which has tracked the device.

Hence, as the software supplier receives the payment for the purchased software, the software supplier automatically redistribute the appropriate portion of the purchase cost to each participant according to a pre-established ratio. These portions can be individually directly sent to each participant or can be pooled and sent regularly (e.g. daily, weekly, monthly, etc.) to each participant.

This redistribution method has several advantages. First, since distributors and retailers only pay for the hardware costs, each device is initially less expensive. Distributors and retailers can therefore build larger inventories without negatively affecting their cashflow.

Second, since devices are sold between participants at a lower price, import duties, which are generally a percentage of the devices' cost, are lower.

In addition, even though the whole system and the tracking and programming methods are configured to support the redistribution method, they can still work with participants which decide to opt out of the redistribution method.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A system for tracking a programmable device along a supply chain, said system comprising:
a) a central server configured to receive, store and transmit information associated with said device;
b) a least one loading station, connected to said central server, for loading first information onto said device, for transmitting said first information to said central server, and for generating an machine-readable identifier comprising second information associated with said first information;
c) a least one tracking station, connected to said central server, for retrieving said second information and for transmitting said second information to said central server; and
d) a least one programming station, connected to said central server, for retrieving said first information from said device and for transmitting said first information to said central server.

2) A method for tracking a programmable device along a supply chain, said method comprising the steps of:
a) at a first location, loading said device with first information, transmitting said first information to a central server, and generating an identifier to be associated with said device, said identifier comprising second information associated with said first information;
b) sending said device to a second location;
c) at said second location, extracting said second information from said identifier and transmitting said second information to said central server;
d) sending said device to a third location;
e) at said third location, extracting said first information from said device, and transmitting said first information to said central server.

3) A method for programming a programmable device, said method comprising the steps:
a) connecting said device to a programming station;
b) extracting first information from said device and transmitting said first information to said central server;
c) retrieving device's configuration from said central server;
d) providing a plurality of selectable features;
e) selecting one or more of said features;
f) transmitting said selection to said central server;
g) retrieving a software corresponding to said selection of said features;
h) programming said device with said software.
